(19) United States
(12) Patent Application Publication
(10) Pub. No.: US 2016/0059762 A1
(43) Pub. Date: Mar. 3, 2016

(54) Integrated Rotatable Cup Holder

(71) Applicant: Goodbaby Child Product Co., Ltd., Kunshan City (CN)

(72) Inventors: Brian Richard Poirier, Lowell, MA (US); Zhang You Cai, Kunshan (CN)

(21) Appl. No.: 14/837,581

(22) Filed: Aug. 27, 2015

Related U.S. Application Data
(60) Provisional application No. 62/042,831, filed on Aug. 28, 2014.

(51) Int. Cl. B60N 3/10; B60N 2/26

(52) U.S. Cl. CPC B60N 3/102; B60N 2/26

(57) ABSTRACT

A cup holder for a child safety seat comprises a rounded depression formed into an edge of the child safety seat, the depression having a cavity therein and an opening therethrough. A first cam surface is disposed within the opening. The cup holder further comprises a cup member having a base, an open side, a concave wall, and an extension arm. The extension arm is attached to the base of the cup member and comprises a second cam surface. The extension arm is positioned within the opening such that the second cam surface is in communication with the first cam surface, such that rotation of the cup member causes the first cam surface to track along the second cam surface. When the cup holder is in an opened state, the concave wall faces inwardly towards the child safety seat, defining a space for receiving a cup.

The present application claims priority to U.S. Provisional Patent Application Ser. No. 62/042,831 for “Integrated Rotatable Cup Holder”, filed Aug. 28, 2014, the disclosure of which is incorporated herein by reference.

### FIELD OF THE DISCLOSURE

The present disclosure generally relates to devices that secure a container and prevent the contents therein from spilling out of the container. Specifically, the present disclosure relates to a rotatable cup holder that may be integrated into a child safety seat, an armrest, a vehicle seat, or any other surface or component.

### BACKGROUND

When traveling in any form, such as by car, bicycle, plane, or simply walking, people often like to bring along a beverage. The beverage may be contained within a cup with an open or closed top. Or, the beverage may be contained within a sealable container with a cap. When thirst arises, one need only access the beverage that they wisely brought along, instead of seeking out some other source to quench his or her thirst.

Cup holders are well known in the art, and a variety of designs currently exist. Automobile manufacturers have integrated a wide variety of cup holders into automobiles. In one example, a cup holder is molded into the dashboard of an automobile. The cup holder may comprise a circular depression within the dashboard that is appropriately sized to accommodate a container or cup. When the cup is placed in the holder, it is secured in place and less likely to fall over and spill. In another example, a cup holder comprises a plastic ring sized to accommodate a cup. The plastic ring fits within a cavity in the car dashboard and can be partially ejected, thus saving interior space when not in use. Accordingly, cup holders within a vehicle allow for a cup or container to be securely placed, freeing the driver to properly operate a vehicle.

Cup holders have been integrated into a wide variety of structures and environments. A bicycle cup holder may comprise a plastic ring attached to a latch that is then secured to the bicycle frame. Airplane food trays feature a slight depression to secure a cup in case of minor turbulence. Infant car seats may feature a cup holder to contain the infant's bottle or other effects. Similarly, an infant's stroller may also feature a cup holder to secure a parent's beverage. Further, cup holders may contain items other than a beverage container, such as a set of keys or other personal minutiae.

There are a number of considerations and issues associated with the design of a cup holder. For example, a cup holder should be appropriately sized to fit a variety of containers. If the cup holder is too large, the container will not be properly secured and will have a higher probability of spilling. This could result in catastrophe if the cup holder is integrated into an automobile and the driver takes a sharp turn. If the cup holder is too small or has an insufficient depth, the container will not fit and the cup holder is then useless. Manufacturers must take into account the likely container size to be used by a consumer and design the cup holder accordingly.

Placement of the cup holder is also an important consideration. Some cup holders may be removable, such as a cup holder designed to be secured to the frame of a bicycle. Others must be integrated with the environment, such as within an automobile interior. In such an environment, a cup holder should ideally be within arm's length of the driver. However, manufacturers must consider whether the cup holder or container will interfere with other components of the car, such as the shifter or radio controls. The cup holder or container should also not interfere with the driver, perhaps by occupying precious elbow room. On an infant's car seat or stroller, the cup holder should be easily accessible to the parent, and perhaps not so accessible to the infant. Accordingly, manufacturers of cup holders must consider a variety of design elements when considering where to place a cup holder.

The materials used to construct the cup holder are also an important consideration. For example, a cup holder consisting of only a plastic ring that is ejectable from an automobile dashboard may be convenient, yet also flimsy and susceptible to breaking. The removable cup holder on a bicycle may present an additional hazard in case of an accident. Further, environmentally conscious consumers may be wary of purchasing cup holders made entirely of plastic or other materials that are not environmentally friendly.

Currently, some of these issues are addressed in a variety of ways, with varying degrees of success. In some cases, the solutions to these issues are expensive, thereby raising the price of the cup holder. It would be beneficial if these issues could be addressed in a safe, convenient, and cost effective manner.

### SUMMARY

The problems of the prior art are addressed by a novel cup holder system. In one embodiment, the problems associated with placing cup holders in a limited space are solved by a cup holder that uses a rotatable and integrated design.

In one embodiment, a cup holder comprises a supporting surface having a rounded depression, the depression having a cavity therein and an opening therethrough. A first cam surface is disposed within the opening. The cup holder further comprises a cup member having one open side and an extension arm with a second cam surface. The extension arm is situated within the opening such that the second cam surface is in communication with the first cam surface. Rotation of the cup member causes the first cam surface to track along the second cam surface, allowing the cup holder to transition from a closed state to an opened state. In further embodiments, the cup holder is in a closed state when the open side of the cup member faces inwardly towards the supporting surface, and the cup holder is in an opened state when the open side of the cup member faces outwardly from the supporting surface. In further embodiments, the cup member comprises a concave surface. The concave surface can comprise a half concave, such that when the cup holder is in the closed state, a space for receiving a cup is defined by the volume between the concave surface and the rounded depression.

In certain embodiments, rotation of the cup member along the first and second cam surfaces raises and lowers the cup member. In further embodiments, the first and second cam surfaces are configured such that the cup member transitions from a raised position to a lowered position as the cup member is rotated by 90 degrees. In further embodiments, the cup holder is in a lowered position when the cup holder is in either the opened or closed state.

In certain embodiments, the cup holder can further comprise a spring in communication with said extension arm. In these embodiments, the spring can bias the cup holder towards the opened or closed states. In certain embodiments, the first and second cam surfaces are positioned such that a base of the cup member is closest to the supporting surface when the cup member is in either the closed state or lowered state, and the base of the cup member is farthest from the supporting surface when the cup member is 90 degrees away from either the closed state or lowered state.

In certain embodiments, the supporting surface is a child safety seat. In these embodiments, the cup member can be shaped so that it substantially conforms to the exterior surface of the child safety seat. Further, the cup holder can be in a closed state when the open side faces the child safety seat, and in an opened state when the open side faces away from the child safety seat. The open side of the cup member can further comprise a concave surface, and serve as a supporting wall of the cup holder. In these embodiments, an edge of the child safety seat serves as an opposite supporting wall, and the supporting walls define a space for receiving a cup. In certain embodiments, the cup member extends over an edge of the child safety seat when the cup holder is in the closed state.

In certain embodiments, the first cam surface can be disposed on a bezel in communication with the opening. In certain embodiments, the cup holder can further comprise a tab positioned at an uppermost portion of the cup member. In certain embodiments, the cup holder can further comprise a detent to bias the cup into either the opened state or closed state when the cup member has reached the opened state or closed state, respectively. In certain embodiments, the first cam surface can comprise a sinusoidal groove molded into the extension arm, and the second cam surface comprises a sinusoidal groove molded into the rounded depression.

In another embodiment, a cup holder for a child safety seat, comprises a rounded depression formed into an edge of the child safety seat, the depression having a cavity therein and an opening therethrough. A first cam surface is disposed within the opening. The cup holder further comprises a cup member comprising a base, an open side, a concave wall, and an extension arm, the extension arm attached to the base of the cup member and comprising a second cam surface. The extension arm is positioned within the opening such that the second cam surface is in communication with the first cam surface, such that rotation of the cup member causes the first cam surface to track along the second cam surface. The cup holder is in a closed state when the concave wall faces inwardly towards the child safety seat, defining a space between the concave wall and the edge of the child safety seat for receiving a cup. In further embodiments, rotation of the cup member along the first and second cam surfaces raises and lowers the cup member. In still further embodiments, the first and cam surfaces are configured such that the cup member transitions from a raised position to a lowered position as the cup member is rotated by 90 degrees.

In another embodiment, a cup holder system includes a supporting surface, such as the edge of a child's a car seat, having a rounded depression with a cavity. A bezel fits within the depression and features an opening that is placed over the cavity. A cup member having one open side and an extension arm is placed onto the bezel, such that the extension arm extends into the opening and into the cavity. This results in a cup holder that is rotatable between open and closed states, depending on whether the open side of the cup member is exposed. The extension arm and bezel feature opposing cam surfaces such that the cup member raises and lowers as it is rotated. As the cup member is rotated, the cup member raises and an integrated spring around the extension arm is compressed. Once the rotational angle of the cup member exceeds a quarter turn, the cam surface will slide downward. The spring force will assist, resulting in the feeling of the cup holder being “pulled” down.

### BRIEF DESCRIPTION OF THE DRAWINGS

Advantages of the present disclosure will be apparent from the following detailed description of exemplary embodiments thereof, which description should be considered in conjunction with the accompanying drawings, in which:

FIG. 1 is a perspective view of a child safety seat containing a cup holder assembly according to one embodiment of the disclosure;

FIG. 2 is a perspective view of the car seat of FIG. 1 that lacks the cup holder assembly;

FIG. 3 is a side view of a car seat containing a cup holder assembly according to one embodiment;

FIGS. 4A-E are perspective views of a rotatable cup holder assembly progressing from an opened state to a closed state according to one embodiment;

FIGS. 5A-5C depict perspective and side views of a cup member in accordance with an embodiment;

FIG. 6 is a perspective view of a bezel in accordance with an embodiment;

FIG. 7 is a perspective view of a cup member coupled to a bezel in accordance with an embodiment;

FIG. 8 is a perspective view of a car seat containing a cup holder assembly according to an embodiment;

FIG. 9 is a cross section view of the car seat, cup member, and bezel along line A-A in FIG. 8;

FIG. 10 is a cross-sectional view of the car seat, cup member, and bezel along line A-A in FIG. 8 after the cup member has been rotated by 90 degrees;

FIG. 11 is a cross-sectional view of the car seat, cup member, and bezel along line B-B in FIG. 8 after the cup member has been rotated by 90 degrees; and

FIG. 12 is a perspective view of a cup holder assembly and detent mechanism according to an embodiment.

### DETAILED DESCRIPTION

The detailed description set forth below in connection with the appended drawings is intended as a description of embodiments and does not represent the only forms which may be constructed and/or utilized. However, it is to be understood that the same or equivalent functions and sequences may be accomplished by different embodiments that are also intended to be encompassed within the spirit and scope of the disclosure, such as rotatable cup holders of different sizes, dimensions, and construction materials.

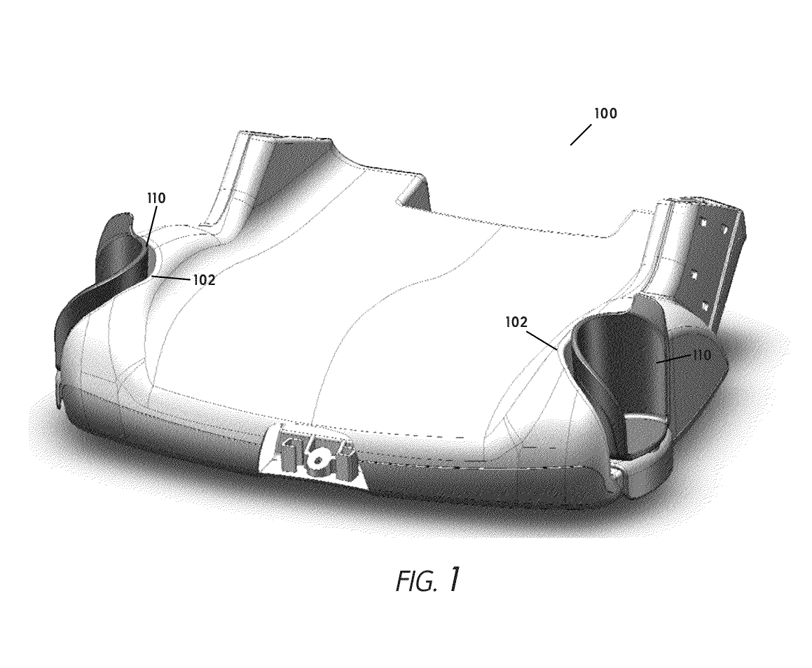

FIG. 1 illustrates a child's safety seat 100 containing a cup holder assembly 110 according to one embodiment. The safety seat 100 is designed to be secured to a seat of a passenger vehicle via an internal restraint system, such as a seat belt or a LATCH system. The safety seat 100 serves as a supporting surface for the cup holder assembly 110, which sits within a rounded depression 102 in the safety seat 100.

Generally, child safety seats are necessary for the younger passengers of an automobile, because vehicle restraint systems are primarily designed to protect adult passengers. Child safety seats are generally placed on the seat of a vehicle and allow for the child occupant to properly use the vehicle's restraint system, or alternately include a restraint system of their own. For example, infants may use rear-facing infant seats, toddlers may use forward-facing child safety seats, and older children may use booster seats. Many states and jurisdictions have laws that mandate the use of such seats to protect child passengers.

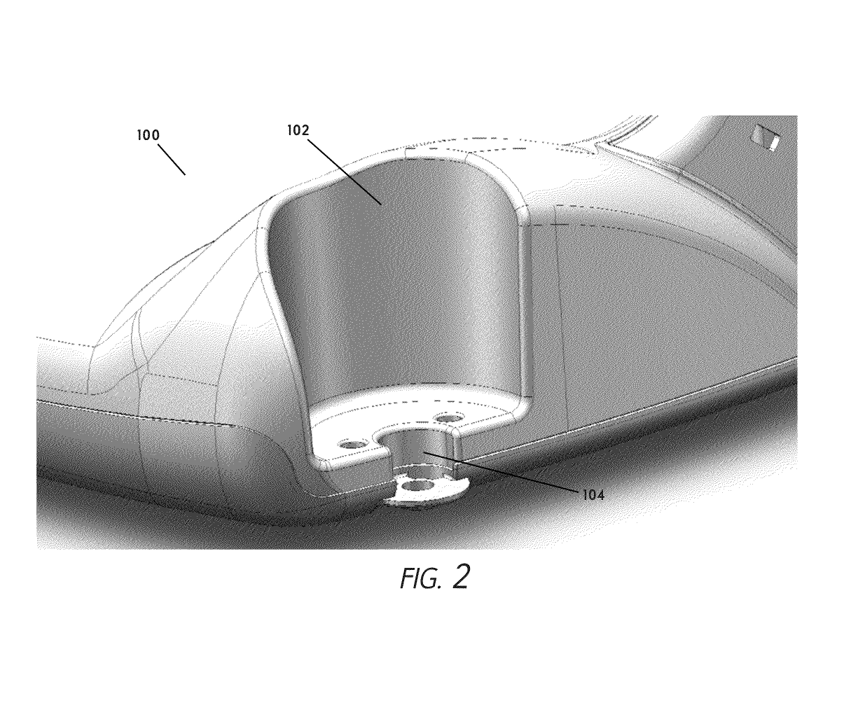

FIG. 2 is a perspective view of the safety seat 100 with the cup holder assembly 110 removed. The depression 102 further comprises a depression cavity 104 that facilitates attachment of the cup holder assembly 110. It should be noted that the cup holder assembly 110 is not limited to only integration with a child's car seat. The cup holder assembly 110 may be integrated into any kind of seat, surface, or environment.

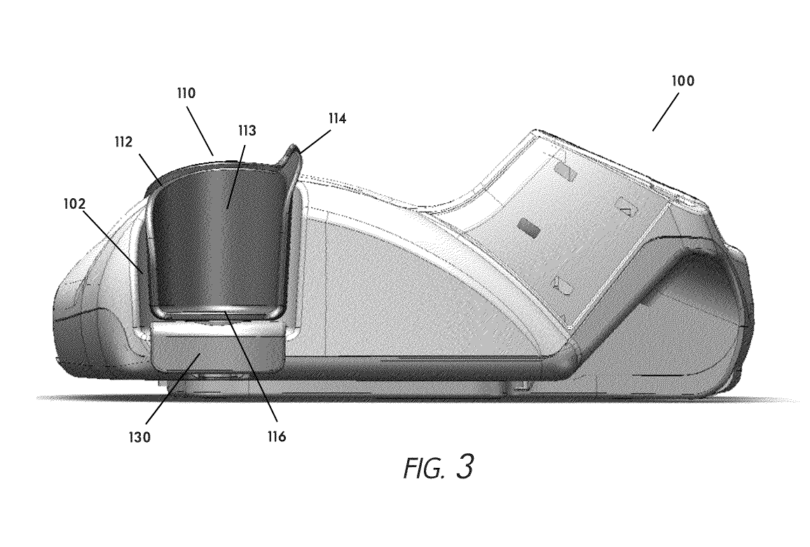

FIG. 3 is a side view of the safety seat 100 and cup holder assembly 110 in accordance with one embodiment. The cup holder assembly 110 comprises a cup member 112, which may be formed of plastic, metal, or any other suitable material. The cup member 112 further comprises a base 116 and a cylindrical sidewall 113 attached thereto. As will be discussed in more detail below, the cup member 112 may also comprise a tab 114 on an uppermost portion of the cup member, and an extension arm attached to the base 116 and having a cam surface. The cup holder assembly 110 further comprises a spring surrounding the extension arm, a washer attached to the extension arm, a bezel having an opening and a cam surface, and a detent mechanism.

The cup member 112, and specifically the base 116, fits within the rounded depression 102 formed into the edge of the safety seat 100. In the embodiment of FIG. 1, each side of the safety seat 100 has a depression 102 and cup holder assembly 110. In other embodiments, a depression 102 and cup holder assembly 110 may only be disposed on one side of the safety seat 100. Further in this embodiment, the cup member 112 is shaped so that the cylindrical sidewall 113 is open on one side. The cup member 112 fits into a bezel 130 that covers and protects the connection between the cup member 112 and the safety seat 100.

The cup member 112 may be shaped so that it substantially conforms to the exterior surface of the safety seat 100. As shown, the cup member 112 fits within the rounded depression 102 of the safety seat 100. In this embodiment, the diameter of the base 116 of the cup member 112 is slightly less than the diameter of the depression 102, so that the cup member 112 fits securely within the depression 102. Further, the shape of the base 116 may not be round, but may be a truncated circle, so that the base 116 does not extend past the safety seat 100. The truncated portion of the base 116 may be on the side opposite the cylindrical sidewall 113. Additionally, the cylindrical sidewall 113 may have an open side, which corresponds with the truncated portion of the base 116. In some embodiments, the height of the cylindrical sidewall 113 may be about the same as the height of the adjacent safety seat 100. In other words, the depth of the depression 102 may be roughly equal to the height of the cylindrical sidewall 113. However, in other embodiments, the cup member 112 may comprise a variety of sizes or shapes.

It should be noted that the cup holder assembly 110 may comprise any combination of a cup member 112 and other supporting surface. In other embodiments, the cup holder assembly 110 may be integrated into surfaces comprising a seat, armrest, dashboard, desk, or bicycle frame.

The cup member 112 further comprises a tab 114 disposed on the cylindrical sidewall 113. The tab 114 may be formed as part of the cup member 112, or alternately it may be formed separately and later attached. In one embodiment, the tab 114 may be removable. In another embodiment, the tab 114 is sized to approximate the average surface area of a person's thumb to better facilitate grasping.

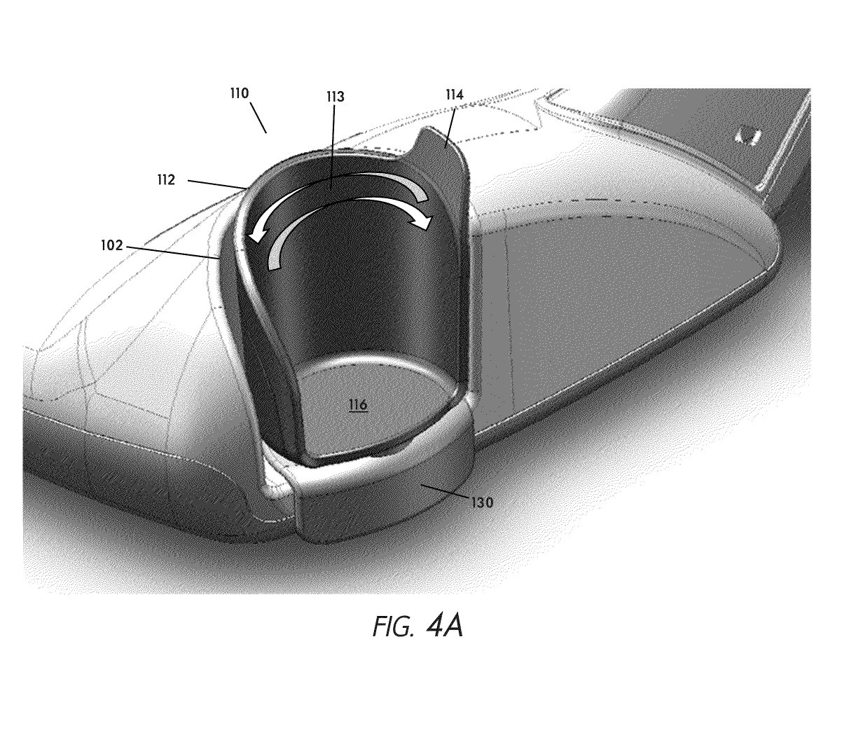

FIG. 4A is a perspective view of a cup holder in an opened state according to an embodiment. In this embodiment, when the cup holder assembly 110 is in the opened state, the base 116 of the cup member 112 does not extend significantly past the edge of the safety seat 100 due to its shape. Additionally, in the opened state, the cylindrical sidewall 113 is disposed on the side nearest the safety seat 100, adjacent to the depression 102, such that the cylindrical sidewall 113 faces outwardly away from the safety seat 100. As shown in this embodiment, the cylindrical sidewall comprises a concave surface. The concave surface can be a half concave, such that when the cup holder is in the closed state, a space for receiving a cup is defined by the volume between the concave surface and the rounded depression. FIGS. 4B-4D are a perspective views of the cup holder assembly 110 between the opened state and a closed state. The views illustrate the cup member 112 rotated by 45, 90, and 135 degrees away from the opened state, respectively.

FIG. 4E is a perspective view of a cup holder in a closed state according to an embodiment of the present disclosure. Continuing to rotate the cup member 112 to 180 degrees places the cup holder assembly 110 in the closed state. In this state, the cup member 112 has been rotated by 180 degrees such that the cylindrical sidewall 113 of the cup member 112 is positioned opposite to the safety seat 100, and thus faces inwardly towards the safety seat 100. A nearly cylindrical space is formed by the edge of the seat surrounding the depression 102 and the cylindrical sidewall 113. Thus, in the closed state, a container may be supported by both the cylindrical sidewall 113 of the cup member 112 and the edge of the safety seat 100 surrounding the rounded depression 102. A container, or other object, is now less likely to fall out of the cup holder assembly 110 because it is supported on both sides.

To transition between the opened and closed states, an operator grips the tab 114 and rotates cup member 112 180 degrees in either the clock wise or counterclockwise direction. Alternatively, the operator may simply grip the cylindrical sidewall 113. In this way, the cup member 112 can be rotated and set such that the cup holder assembly 110 transitions from the opened state (FIG. 4A) to the closed state (FIG. 4E).

In practice, the cup holder assembly 110 in the opened state may not be suitable for holding a cup or other items, as one side of the cup holder assembly 110 is open and thus exposed. However, when the cup member 112 is rotated 180 degrees in either direction, whether clockwise or counter-clockwise, it will enter the closed state wherein the cylindrical sidewall 113 of the cup member 112 serves as a supporting wall of the cup holder assembly 110, with the edge of the safety seat 100 surrounding the depression 102 serving as the opposing wall. In this way, a cup, set of keys, or other item may be secured within the cup holder assembly 110. Once the items are removed, the cup holder assembly 110 may be returned to the opened state by rotating the cup member 112 in either direction.

In one embodiment, the cup holder assembly 110 in the closed state extends beyond the edge of the safety seat 100. Thus, the cup holder assembly 110 in the closed state presents a larger exterior surface for the safety seat 100 than it does when the cup holder assembly 110 is in the opened state. In this way, the cup holder assembly 110 can be integrated into environments where available space is a consideration. When the cup holder assembly 110 is no longer needed to hold a cup, it is transitioned to the opened state to save space.

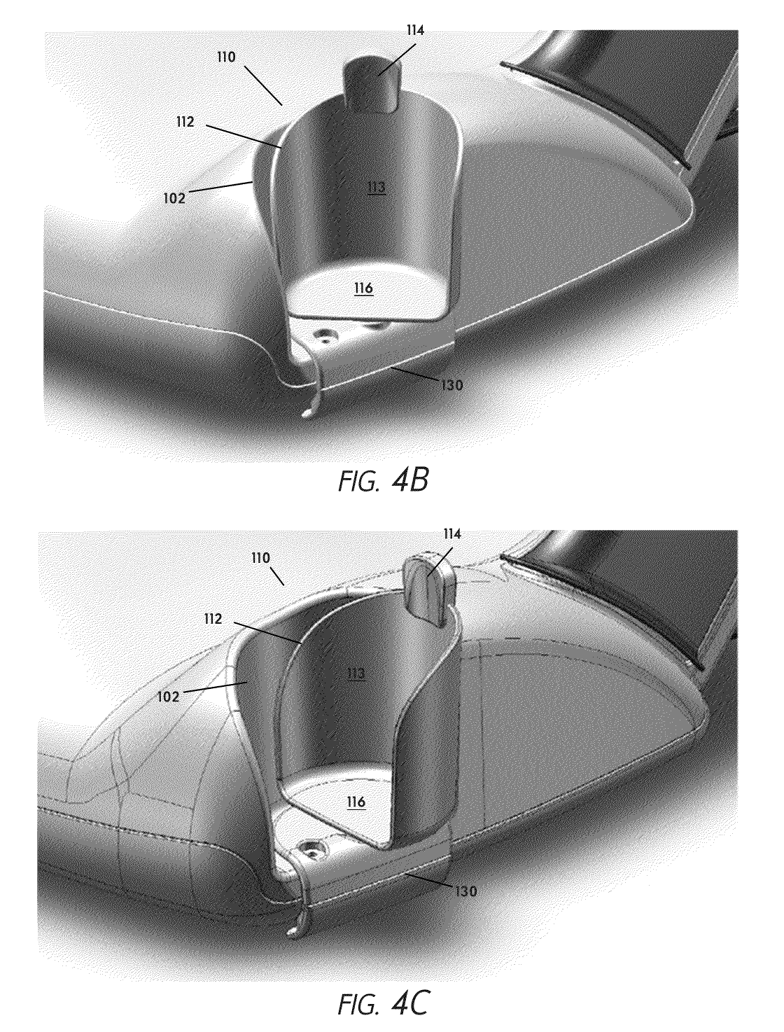

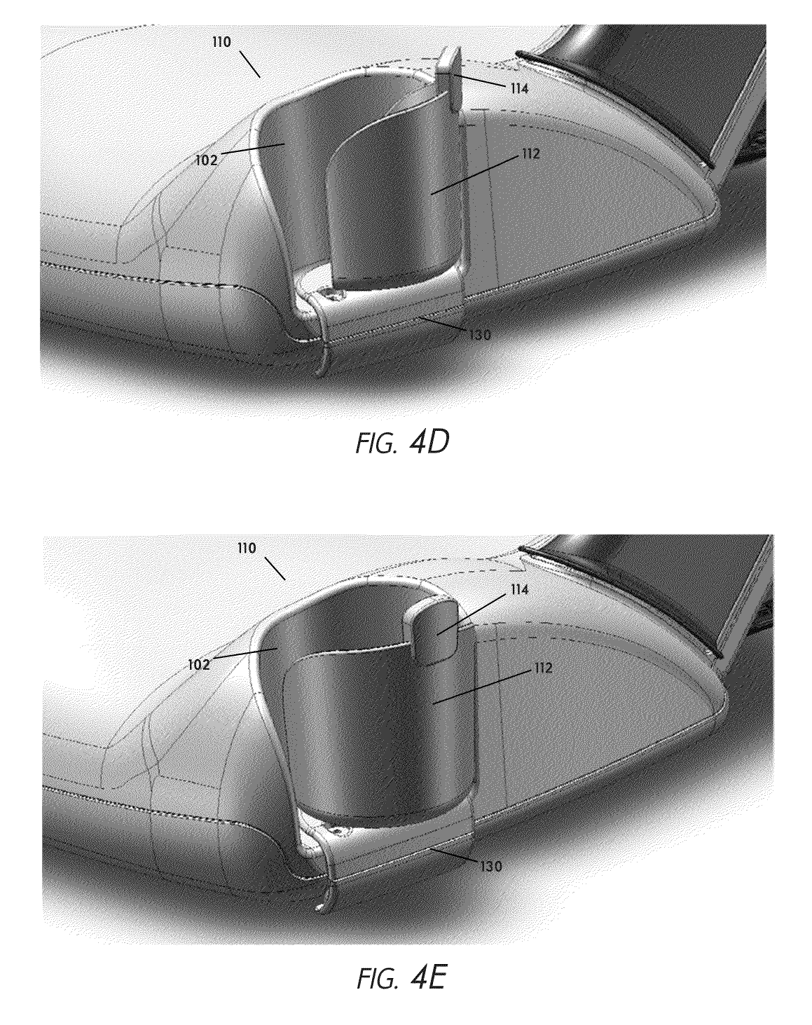

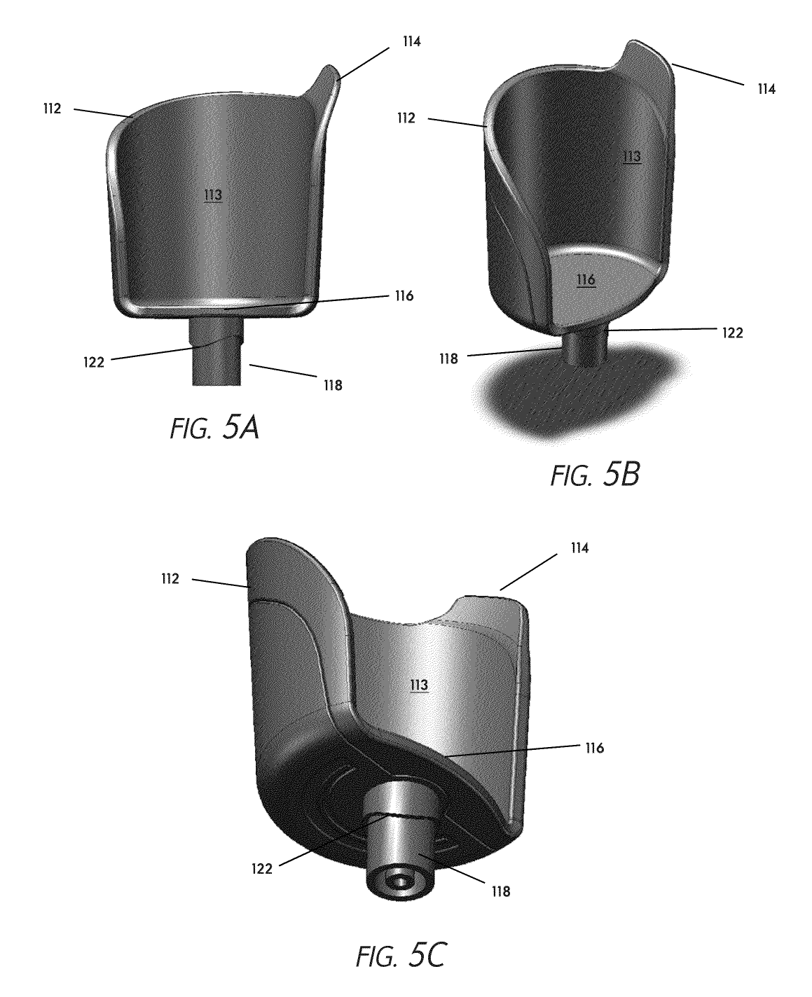

FIGS. 5A-5C illustrate the cup member 112 in accordance with the embodiment shown in FIGS. 3-4. Attached to the bottom of the base 116 of the cup member 112 is an extension arm 118. The extension arm 118 may be molded as part of the cup member 112, or alternately may be simply a dowel affixed to the bottom of base 116. The extension arm 118 features a cam surface 122, which may be directly molded onto the extension arm 118, or formed separately and slid over the extension arm 118 into position. In this embodiment, the cam surface 122 is a sinusoidal groove molded into the extension arm 118. In other embodiments, the cam surface 122 may be a sinusoidal disc affixed to the extension arm 118. As will be illustrated and described in detail below, the cam surface 122 allows the cup member 112 to smoothly raise and lower into position under load from a spring 124.

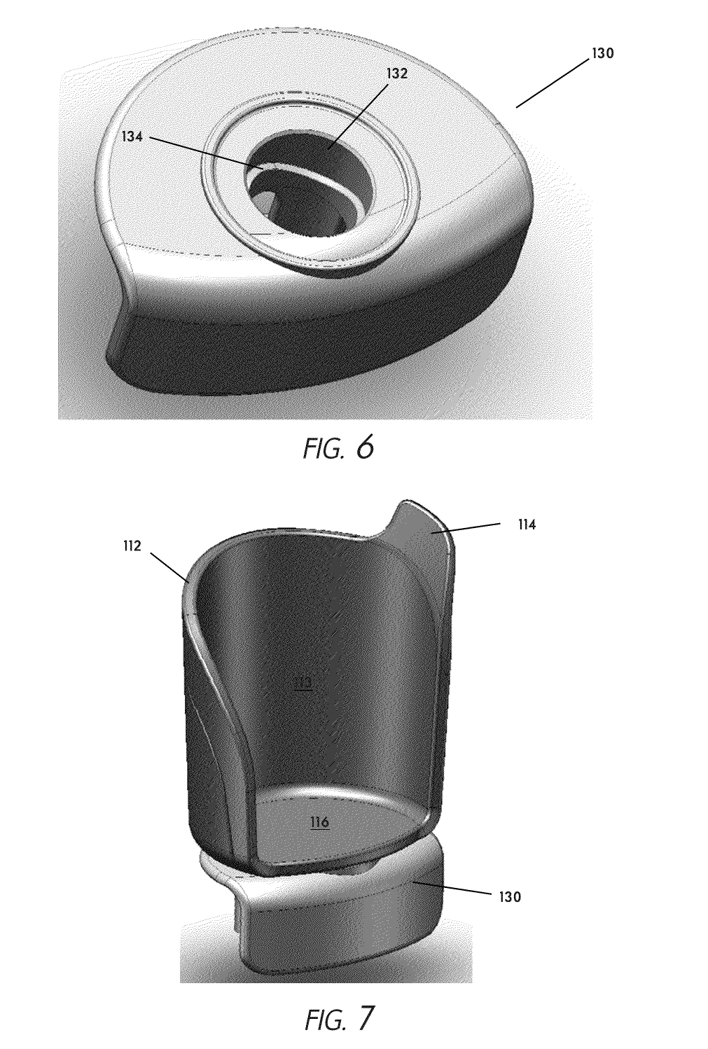

FIG. 6 illustrates a bezel 130 in accordance with an embodiment of the present invention. The bezel 130 attaches to the safety seat 100 within the rounded depression 102 and presents an interface for both the depression cavity 104 and cup member 112. The bezel 130 features an opening 132 having an inner cam surface 134. Similar to the cam surface 122 on the extension arm 118, the bezel inner cam surface 134 is a sinusoidal groove. In operation, the extension arm 118 of the cup member 112 is placed into the bezel opening 132 such that the inner cam surface 134 of the bezel 130 interfaces with the cam surface 122 of the cup member 112. As the cup member 112 rotates, the cam surfaces 122, 134 interact and track along one another, causing the cup member 112 to raise and lower. When the cam surfaces 122, 134 interface such that each sinusoid groove is at a maximum, the cup member 112 reaches a maximum height. Similarly, when the cam surfaces 122, 134 interface such that the sinusoid groove is at a minimum, the cup member 112 reaches a minimum height. Thus, in this way, rotating the cup member 112 causes the cup member 112 to raise and lower.

The extension arm cam surface 122 and bezel inner cam surface 134 are positioned so that the cup holder is at its lowest position in both the open and closed states, and at its highest position when the cup member 112 is 90 degrees away from either the open or closed state. The cup member 112 may rotate either clockwise or anti-clockwise.

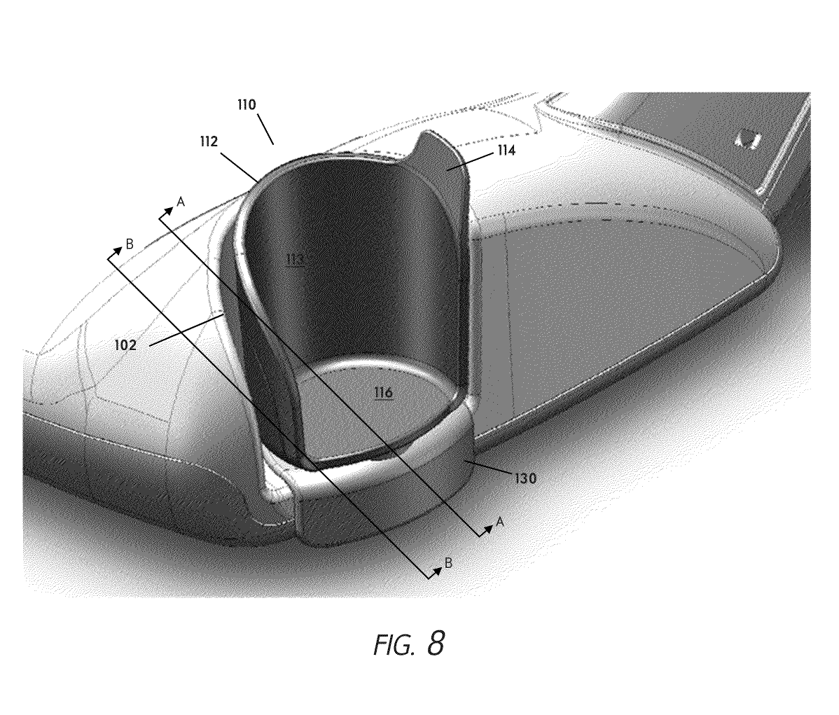

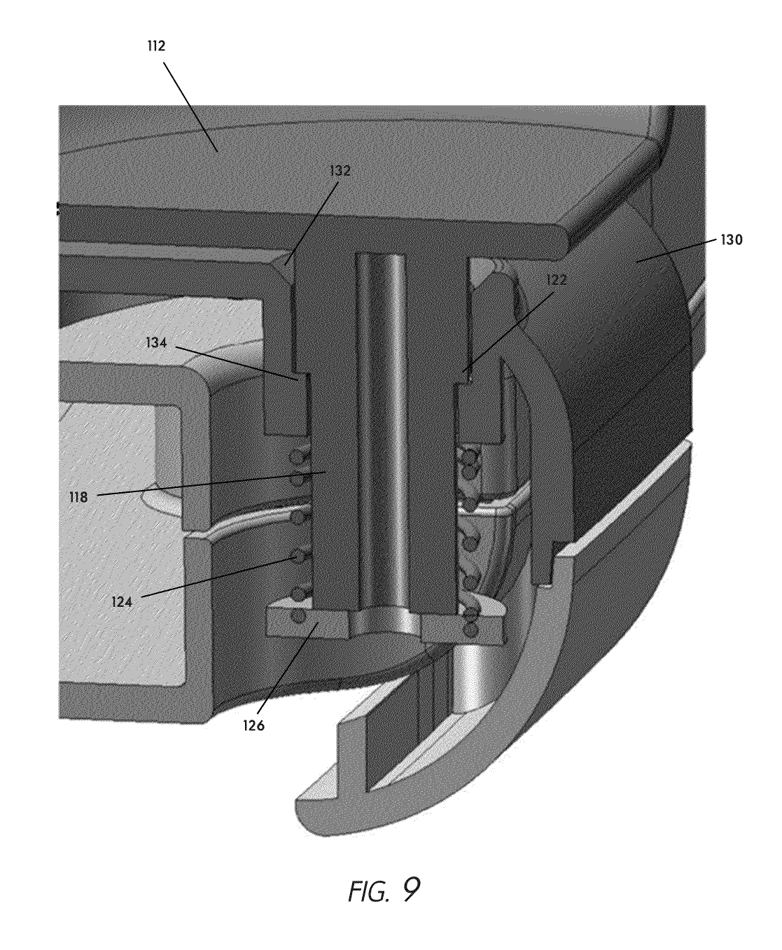

FIG. 7 depicts the cup member 112 attached to the bezel 130. FIG. 8 depicts the cup member 112 attached to the bezel 130, which in turn is coupled to the depression cavity 104 (see also FIG. 2). FIG. 9 is a cross-sectional view of line A-A as shown in FIG. 8, and shows in detail the interface between the cup member 112, bezel 130, and safety seat 100. A spring 124 surrounds the extension arm 118 and is positioned below the interface of the cam surfaces 122, 134. The spring 124 is disposed between the underside of the bezel 130 and the washer 126.

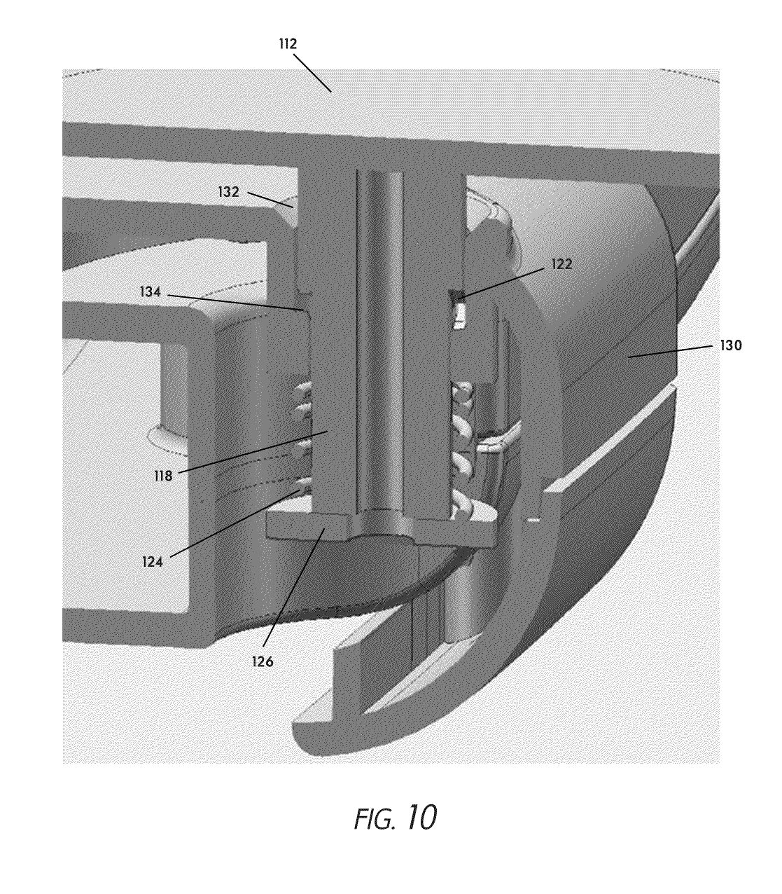

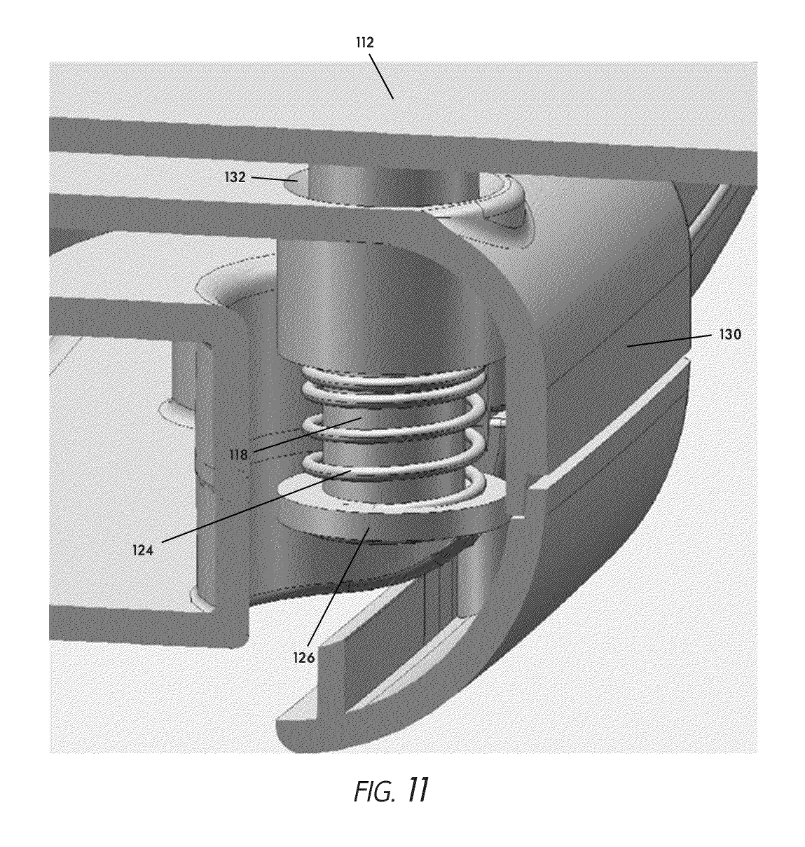

FIG. 10 is a cross-sectional view of line A-A from FIG. 8 as the cup member 112 is rotated by 90 degrees. As the cup member 112 rotates, the cam surface 122 rides on top of the bezel inner cam surface 134, thus raising and lowering the cup member 112. Rotating and raising the cup member 112 causes the washer 126 to move closer to the underside of the bezel 130, and thereby compresses the spring 124 against the washer 126 and bezel inner cam surface 134. Once the rotational angle of the cup member 112 exceeds a quarter turn, the cam surface 122 will begin to slide downward. The accumulated force in the compressed spring 124 will then assist in rotating the cup member 112, resulting in the feeling of the cup member 112 being “pulled” downwards. Thus, the spring biases the cup holder to either the opened or closed states.

FIG. 11 is a cross-sectional view of line B-B from FIG. 8 as the cup member 112 is rotated by 90 degrees. This view illustrates the spring 124 as it biases the washer 126 and extension arm 118 away from the top of the bezel 130.

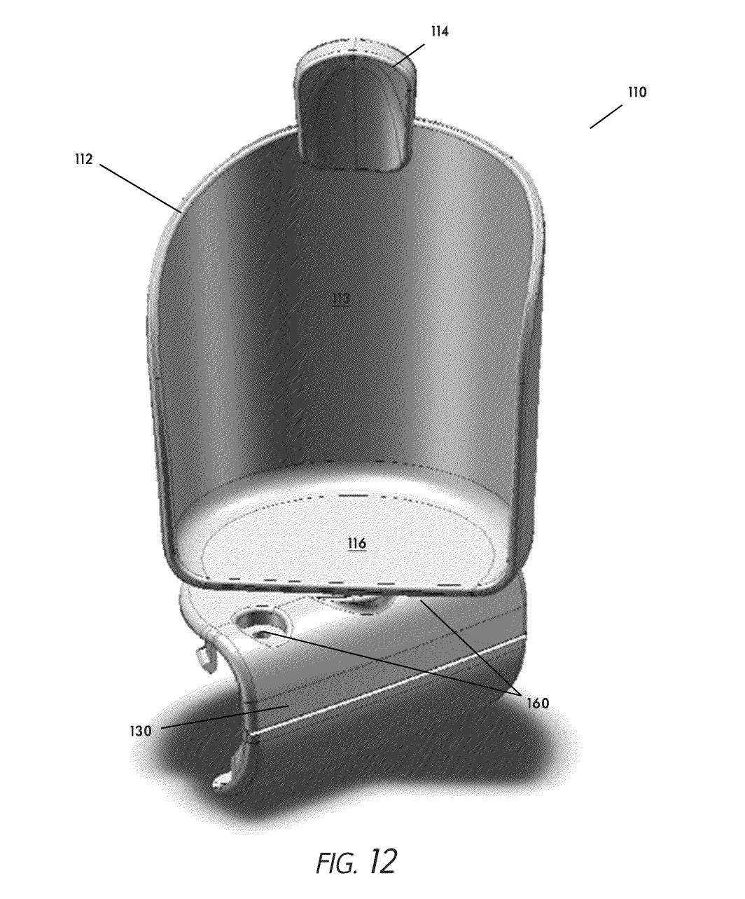

FIG. 12 illustrates another embodiment of the present invention. In this embodiment, the cup holder assembly 110 features a detent mechanism 160 that releasably secures the cup member 112 in either the open or closed state. The detent mechanism 160 further secures the cup in position and prevents unwanted movement. In one embodiment, the detent mechanism 160 comprises grooves formed in the top of the bezel 130 with corresponding protrusions in the base 116 of the cup member 112. As the cup member 112 rotates and enters either the open or closed states, the protrusions come into contact with the grooves. Rotation of the cup member 112 is then arrested, thus maintaining the present position. Because the detent mechanism 160 secures the cup member 112 in either the open or closed state, the detent mechanism 160 may be used in lieu of, or to supplement, the spring 124 and cam surfaces 122, 134.

In another embodiment, the cup holder assembly 110 lacks a bezel 130. In this embodiment, the inner cam surface 134 is embedded into the safety seat 100. In one example, the inner cam surface 134 is molded into the depression cavity 104. Many other variations will be evident to those having skill in the art.

In conclusion, herein is presented a rotatable cup holder that may be integrated into an armrest, seat, or any other surface or component. The invention is illustrated by example in the drawing figures, and throughout the written description. It should be understood that numerous variations are possible, while adhering to the inventive concept. Such variations are contemplated as being a part of the present invention.

What is claimed is:

1. A cup holder comprising:
a supporting surface having a rounded depression, the rounded depression comprising a cavity therein and an opening therethrough;
a first cam surface disposed within the opening;
a cup member with one open side and further comprising an extension arm with a second cam surface, the extension arm situated within the opening such that the second cam surface is in communication with the first cam surface;
wherein rotation of the cup member causes the first cam surface to track along the second cam surface, allowing the cup holder to transition from a closed state to an opened state.

2. The cup holder of claim 1, wherein the cup holder is in a closed state when the open side of the cup member faces inwardly towards the supporting surface, and the cup holder is in an opened state when the open side of the cup member faces outwardly from the supporting surface.

3. The cup holder of claim 1, wherein the cup member comprises a concave surface.

4. The cup holder of claim 3, wherein the concave surface comprises a half concave, such that when the cup holder is in the closed state, a space for receiving a cup is defined by the volume between the concave surface and the rounded depression.

5. The cup holder of claim 1, wherein rotation of the cup member along the first and second cam surfaces raises and lowers the cup member.

6. The cup holder of claim 5, wherein the first and second cam surfaces are configured such that the cup member transitions from a raised position to a lowered position as the cup member is rotated by 90 degrees.

7. The cup holder of claim 6, wherein the cup holder is in a lowered position when the cup holder is in either the opened or closed state.

8. The cup holder of claim 1, further comprising a spring in communication with said extension arm, wherein the spring biases the cup holder towards the opened or closed states.

9. The cup holder of claim 1, wherein the first and second cam surfaces are positioned such that a base of the cup member is closest to the supporting surface when the cup member is in either the closed state or lowered state, and the base is farthest from the supporting surface when the cup member is 90 degrees away from either the closed state or lowered state.

10. The cup holder of claim 1, wherein the supporting surface is a child safety seat.

11. The cup holder of claim 10, wherein the cup member is shaped so that it substantially conforms to an exterior surface of the child safety seat.

12. The cup holder of claim 10, wherein the cup holder is in a closed state when the open side faces the child safety seat, and the cup holder is in an opened state when the open side faces away from the child safety seat.

13. The cup holder of claim 12, wherein the open side of the cup member comprises a concave surface and serves as a supporting wall of the cup holder, and an edge of the child safety seat serves as an opposite supporting wall, the supporting walls defining a space for receiving a cup or other object.

14. The cup holder of claim 10, wherein the cup member extends over an edge of the child safety seat when the cup holder is in the closed state.

15. The cup holder of claim 1, wherein the first cam surface is disposed on a bezel in communication with the opening.

16. The cup holder of claim 1, further comprising a detent to bias the cup into either the opened state or closed state when the cup member has reached the opened state or closed state, respectively.

17. The cup holder of claim 1, wherein the first cam surface comprises a sinusoidal groove molded into the extension arm and the second cam surface comprises a sinusoidal groove molded into the rounded depression.

18. A cup holder for a child safety seat, comprising:
a rounded depression formed into an edge of the child safety seat, the depression having a cavity therein and an opening therethrough;
a first cam surface disposed within the opening;
a cup member comprising a base, an open side, a concave wall, and an extension arm, the extension arm attached to the base of the cup member and comprising a second cam surface, the extension arm positioned within the opening such that the second cam surface is in communication with the first cam surface, such that rotation of the cup member causes the first cam surface to track along the second cam surface;
wherein the cup holder is in a closed state when the concave wall faces inwardly towards the child safety seat, defining a space between the concave wall and the edge of the child safety seat for receiving a cup.

19. The cup holder of claim 18, wherein rotation of the cup member along the first and second cam surfaces raises and lowers the cup member.

20. The cup holder of claim 18, wherein the first and cam surfaces are configured such that the cup member transitions from a raised position to a lowered position as the cup member is rotated by 90 degrees.
